(19) United States
(12) Patent Application Publication
(10) Pub. No.: US 2026/0339155 A1
(43) Pub. Date: Oct. 29, 2026

(54) HIGH-FLEXIBILITY IRIDESCENT FILM, COATING SOLUTION FORMULA THEREOF, AND MANUFACTURING METHODS THEREFOR

(71) Applicant: BD (Xiamen) Technology Co., Ltd., Fujian (CN)

(72) Inventors: Po Yen CHOU, Fujian (CN); Jingguo ZHUANG, Fujian (CN); Jiahu WEI, Fujian (CN)

(21) Appl. No.: 19/540,565

(22) Filed: Feb. 13, 2026

(30) Foreign Application Priority Data
Apr. 25, 2025 (CN) 2025105277023
Apr. 25, 2025 (CN) 2025207983515

(51) Int. Cl. G02F 1/137; C09K 19/58; G02F 1/1337

(52) U.S. Cl. CPC G02F 1/13718; C09K 19/586; C09K 19/588; G02F 1/133788; C09K 2323/00

(57) ABSTRACT

A coating solution formula containing cholesteric liquid crystal epoxy resin, acetone, butyl glycidyl ether, a chiral dopant, and triethylenetetramine. A high-flexibility iridescent film having an iridescent coating containing a coating solution according to the coating solution formula, and manufacturing methods for the coating solution and the high-flexibility iridescent film are also provided.

### TECHNICAL FIELD

The present invention pertains to the technical field of optical materials, and particularly relates to a high-flexibility iridescent film, a coating solution formula, and manufacturing methods therefor.

### BACKGROUND OF THE INVENTION

Currently, TAC (Tri-Acetyl Cellulose) film eyeglass lenses or other optical film eyeglass lenses available on the market are made by processing optical film materials and then forming a compound material through multi-layer lamination. Subsequently, the compound material is cut into required small sizes and shaped into specific curvatures through a baking and bending process to form lenses. Thereafter, the formed lenses are sent for electroplating to achieve desired color effects. After electroplating is completed, the lenses also need to be trimmed to sizes suitable for frames of different eyeglasses. Finally, the trimmed lenses are assembled into the frames to complete the production of eyeglasses.

Electroplating processes are mainly divided into wet electroplating and vacuum electroplating, both of which serves the same core purpose of plating a metal film on a lens surface to enhance performance of the lens, protect the lens, and improve aesthetic appearance of the lens. With intensification of market competition and diversification of demands, designs and processing technologies of lenses have also undergone significant changes. Due to its chemical and mechanical characteristics, an electroplated layer is neither resistant to acids and alkalis nor resistant to scratches, making it extremely susceptible to irreversible damages. Such damages not only affect wearing experience and appearance of the lens but may also pose threats to user's eyes during long-term wearing of damaged lens. In addition, physical rigidity of the electroplated layer limits its use in designing and making new eyeglasses having greater curvatures since the electroplated layer may easily crack when used in such new eyeglasses.

### BRIEF SUMMARY OF THE INVENTION

In view of the problems existing in the prior art, the primary objectives of the present invention are to provide a high-flexibility iridescent film, a coating solution formula, and manufacturing methods therefor. The present invention can retain all beneficial effects of electroplated lenses, and at the same time solving problems like the lack of resistance to chemical corrosion, insufficient flexibility, and susceptibility to cracking at greater curvatures existing in prior art electroplated sheets.

To attain the above objectives, the present invention provides the following technical solutions:

According to a first aspect, the present invention provides a coating solution formula, comprising the following ingredients: a cholesteric liquid crystal epoxy resin, acetone, butyl glycidyl ether, a chiral dopant, and triethylenetetramine.

A ratio of one or both of the acetone and the butyl glycidyl ether to the chiral dopant can be adjusted to adjust a pitch of the liquid crystal molecules in the coating solution formula according to predetermined requirements for a reflection wavelength; the reflection wavelength λ is obtained by λ=2n·P·sin Φ, and

$$λ = \frac{2 n \cdot sin Φ}{C \cdot β M} ,$$

wherein

$$n = \frac{2 {n}_{0} + {n}_{e}}{3}$$

represents an average refractive index of the liquid crystal molecules, n₀ represents an ordinary refractive index, nₑ represents an extraordinary refractive index, P represents the pitch, Φ represents an angle between incident light and a surface of a liquid crystal, C represents a concentration of the chiral dopant, and βM represents a helical twisting power.

Preferably, mass percentages of the ingredients in the coating solution formula are: the cholesteric liquid crystal epoxy resin accounts for 42% of the coating solution, the acetone accounts for 33% of the coating solution, the butyl glycidyl ether accounts for 20% of the coating solution, the chiral dopant accounts for 0.4% of the coating solution, and the triethylenetetramine accounts for 4.6% of the coating solution.

The chiral dopant is chiral dopant S811.

According to a second aspect of the present invention, the present invention discloses a manufacturing method of a coating solution, implemented in a dust-free environment at a constant temperature of 23 °C±1 °C and a constant pressure, and comprising the following steps:
step 1: collecting the ingredients according to the coating solution formula described above, placing the cholesteric liquid crystal epoxy resin in a stirrer, and stirring the cholesteric liquid crystal epoxy resin at a uniform speed of 35 r/min in a clockwise direction;
step 2: maintaining a rotation speed of the stirrer, adding the acetone and the butyl glycidyl ether into the stirrer, and continuing stirring for 30 minutes;
step 3: maintaining the rotation speed of the stirrer, adding the chiral dopant into the stirrer, and continuing stirring for 30 minutes;
step 4: maintaining the rotation speed of the stirrer, adding the triethylenetetramine into the stirrer, continuing stirring for 60 minutes until a liquid crystal phase is uniformly dispersed, and then stopping the stirrer; and finally allowing the ingredients to rest, vacuuming to remove air to obtain the coating solution.

According to a third aspect of the present invention, the present invention provides a high-flexibility iridescent film, comprising at least one substrate layer and an iridescent coating coated on a surface of one of said at least one substrate layer; said iridescent coating comprises a coating solution obtained according to the coating solution formula described above; the coating solution is nano-spray coated on the surface of one of said at least one substrate layer to obtain said iridescent coating.

The substrate layer is a glass material or a plastics material, and the plastics material is one or more of Tri-Acetyl Cellulose (TAC), Polycarbonate (PC), Polyamide (PA), and Poly-methyl methacrylate (PMMA).

A manufacturing method of the high-flexibility iridescent film, comprising the following steps:
step 1: presetting startup parameters on a main control screen;
step 2: setting a distance between a nozzle and said surface of one of said at least one substrate layer to 5-25 cm;
step 3: preparing the coating solution obtained according to the coating solution formula described above;
step 4: injecting the coating solution into a material storage tank, and quantitatively delivering the coating solution to said surface of one of said at least one substrate layer which is an atomization surface through a metering pump to achieve ultrasonic atomization nano-spray coating; wherein an ultrasonic atomization frequency is 80-120 kHz, and a power thereof is 50-200 W;
step 5: allowing said one of said at least one substrate layer having the coating solution coated thereon to enter an oven to achieve curing, and the oven temperature is set greater than 60 °C and less than 245 °C, and a time for achieving the curing in the oven is not less than 24 hours;
the iridescent film is eventually obtained with at least one layer of said iridescent coating coated on said surface of one of said at least one substrate layer; a total thickness of the iridescent coating comprising at least one layer is 1 nm to 50 μm.

Preferably, when adjusting a color-displaying wavelength of the iridescent coating, a color displayed by the iridescent coating is changed by adjusting the pitch of a helical structure of liquid crystal molecules in the iridescent coating, and adjustment of the pitch is achieved by adjusting at least one of a helical twisting power, a concentration of the chiral dopant, an average refractive index of the liquid crystal molecules, and a temperature of the coating solution.

According to the above technical solutions, the present invention has the following technical effects:

The present invention aims to address deficiencies of electroplated lenses which are weak in flexibility and resistance to chemical corrosion, as well as issues such as susceptibility to cracking of the electroplated layer when bent to greater curvatures. The present invention provides an innovative coating solution formula. The coating solution obtained can be used to prepare an iridescent film having high flexibility and multi-angle color display; the iridescent film is based on known principles of anisotropy of liquid crystals and Bragg reflection to display colors by multi-layer superposition and interference. Thus, the present invention can retain all beneficial effects of electroplated lenses, and at the same time solving problems like the lack of resistance to chemical corrosion, insufficient flexibility, and susceptibility to cracking at greater curvatures existing in prior art electroplated sheets. A finished product of the flexible iridescent film can be supplied in form of a roll, preventing increased process steps, rising production costs, and resource waste caused by conventional electroplating processes.

### BRIEF DESCRIPTION OF THE DRAWINGS

FIG. 1 is a schematic structural diagram of an optical iridescent film according to a third embodiment of the present invention.

FIG. 2 is a spectral curve of an optical iridescent film in red according to the third embodiment of the present invention.

FIG. 3 is a spectral curve of an optical iridescent film in green according to the third embodiment of the present invention.

FIG. 4 is a spectral curve of an optical iridescent film in blue according to the third embodiment of the present invention.

FIG. 5 is a schematic structural diagram of a high-flexibility iridescent transfer film according to a fourth embodiment of the present invention.

FIG. 6 is a schematic structural diagram of a high-flexibility iridescent protective film according to a fifth embodiment of the present invention.

FIG. 7 is a schematic structural diagram of a high-flexibility iridescent colored film according to a sixth embodiment of the present invention.

FIG. 8 is a schematic structural diagram of a high-flexibility iridescent color-changing film according to a seventh embodiment of the present invention.

FIG. 9 is a schematic structural diagram of a high-flexibility iridescent polarizing film according to an eighth embodiment of the present invention.

FIG. 10 is a schematic structural diagram of an iridescent polarizing film (having iridescent film in red) according to the eighth embodiment of the present invention.

FIG. 11 is a schematic structural diagram of an iridescent polarizing film (having iridescent film in green) according to the eighth embodiment of the present invention.

FIG. 12 is a schematic structural diagram of an iridescent polarizing film (having iridescent film in blue) according to the eighth embodiment of the present invention.

FIG. 13 is a schematic structural diagram of a high-flexibility iridescent polarizing color-changing film according to a ninth embodiment of the present invention.

FIG. 14 is a schematic structural diagram of a high-flexibility anti-fog polarizing color-changing iridescent film according to a tenth embodiment of the present invention.

### REFERENCE SIGNS IN THE DRAWINGS

1—iridescent coating; 2—substrate layer; 3—release film; 4—(first) protective film (4′—second protective film); 5—colored film; 6—anti-UV film; 7—color-changing film; 8—polarizing film; 9—anti-fog film.

### DETAILED DESCRIPTION OF THE INVENTION

To further explain the technical solutions of the present invention, the present invention is described in detail below with reference to specific embodiments.

A first embodiment of the present invention discloses a coating solution formula, comprising the following ingredients: a cholesteric liquid crystal epoxy resin (R/L helical structure), acetone (a solvent), butyl glycidyl ether (a solvent), a chiral dopant, and triethylenetetramine (an aliphatic polyamine thermosetting curing agent). Among them, a mixture of the acetone and the butyl glycidyl ether can quickly adjust viscosity of the coating solution and reduce curing defects; R/L represents helical structure of the liquid crystal molecules, with R being right-handed and L being left-handed.

Further, a ratio of one or both of the acetone and the butyl glycidyl ether to the chiral dopant can be adjusted to adjust a pitch of the liquid crystal molecules in the coating solution formula according to predetermined requirements for a reflection wavelength; the reflection wavelength λ is obtained by λ=2n·P·sin Φ, and

$$λ = \frac{2 n \cdot sin Φ}{C \cdot β M} ,$$

wherein

$$n = \frac{2 {n}_{0} + {n}_{e}}{3}$$

represents an average refractive index of the liquid crystal molecules, n₀ represents an ordinary refractive index, nₑ represents an extraordinary refractive index, P represents the pitch, Φ represents an angle between incident light and a surface of a liquid crystal, C represents a concentration of the chiral dopant, and βM represents a helical twisting power.

Furthermore, a mass ratio of the ingredients in the coating solution formula is as follows:
the cholesteric liquid crystal epoxy resin accounts for 42%, the acetone accounts for 33%, the butyl glycidyl ether accounts for 20%, the chiral dopant accounts for 0.4%, and the triethylenetetramine accounts for 4.6%.

The chiral dopant may be chiral dopant S811.

A second embodiment of the present invention discloses a manufacturing method of a coating solution, implemented in a dust-free environment at a constant temperature of 23 °C±1 °C and a constant pressure, and comprising the following steps:
Step 1: collecting the ingredients according to the coating solution formula described above, placing the cholesteric liquid crystal epoxy resin in a stirrer, and stirring the cholesteric liquid crystal epoxy resin at a uniform speed of 35 r/min in a clockwise direction;
Step 2: maintaining a rotation speed of the stirrer, adding the acetone and the butyl glycidyl ether into the stirrer, and continuing stirring for 30 minutes;
Step 3: maintaining the rotation speed of the stirrer, adding the chiral dopant into the stirrer, and continuing stirring for 30 minutes;
Step 4: maintaining the rotation speed of the stirrer, adding the triethylenetetramine into the stirrer, continuing stirring for 60 minutes until a liquid crystal phase is uniformly dispersed, and then stopping the stirrer; and finally allowing the ingredients to rest, vacuuming to remove air to obtain the coating solution.

A third embodiment of the present invention discloses a high-flexibility iridescent film manufactured by a nano-spray coating process; a manufacturing method thereof comprises the following steps:
Step 1: presetting startup parameters on a main control screen;
Step 2: setting a distance between a nozzle and a substrate layer 2 to 5-25 cm, with an optimal distance being 21 cm;
Step 3: preparing a coating solution according to the coating solution formula described above;
Step 4: injecting the coating solution into a material storage tank, and quantitatively delivering the coating solution to an atomization surface of the substrate layer through a metering pump to achieve ultrasonic atomization nano-spray coating; wherein an ultrasonic atomization frequency is 80-120 kHz, preferably 120 kHz, and a power thereof is 50-200 W, preferably 150 W;
Step 5: allowing the substrate having the coating solution coated thereon to enter an oven to achieve curing; an oven temperature can be set for a single chamber or multiple chambers according to specific requirements, and the oven temperature has to be set greater than 60 °C and less than 245 °C; a time for achieving the curing in the oven is not less than 24 hours;

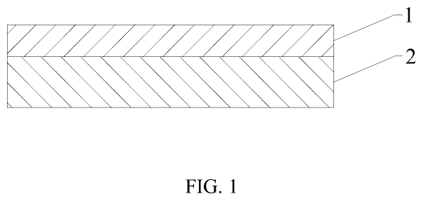

As shown in FIG. 1, the iridescent film is eventually obtained with at least one layer of iridescent coating 1 coated on a surface of the substrate layer 2; in actual production, there may be two, three, or even more layers of iridescent coating 1. A total thickness of the iridescent coating 1 comprising at least one layer is 1 nm to 50 μm.

Further, the substrate layer 2 can be a glass material or a plastics material, and the plastics material can be one or more of TAC (Tri-Acetyl Cellulose), PC (Polycarbonate), PA (Polyamide), and PMMA (Poly-methyl methacrylate); when the substrate layer comprises multiple materials, the various materials are stacked sequentially. Among them, when the substrate layer 2 is TAC, the substrate layer 2 needs to undergo activation treatment to increase surface activity and improve a bonding degree between the iridescent coating 1 and the substrate layer 2.

Also, when adjusting a color-displaying wavelength of the iridescent coating 1, the color is changed by adjusting the pitch of the helical structure of the liquid crystal molecules in the iridescent coating 1, and adjustment of the pitch is achieved by adjusting at least one of the helical twisting power, the concentration of the chiral dopant, the average refractive index of the liquid crystal molecules, and a temperature of the coating solution.

When the high-flexibility iridescent film undergoes a flexibility test, the iridescent coating 1 can be manually folded 180° and pressed without cracking. Also, the high-flexibility iridescent film can display visible colors in seven spectra of red, orange, yellow, green, blue, indigo, and violet.

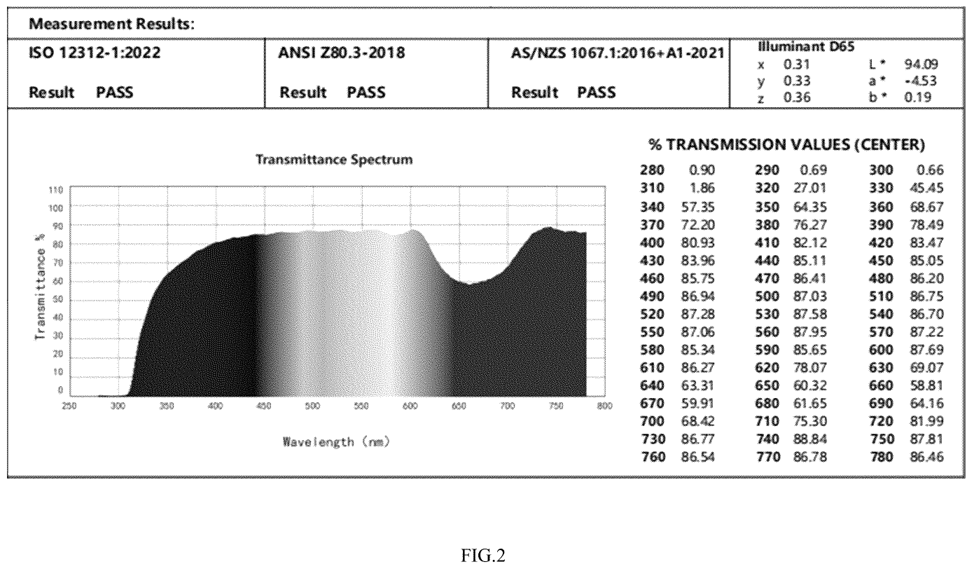

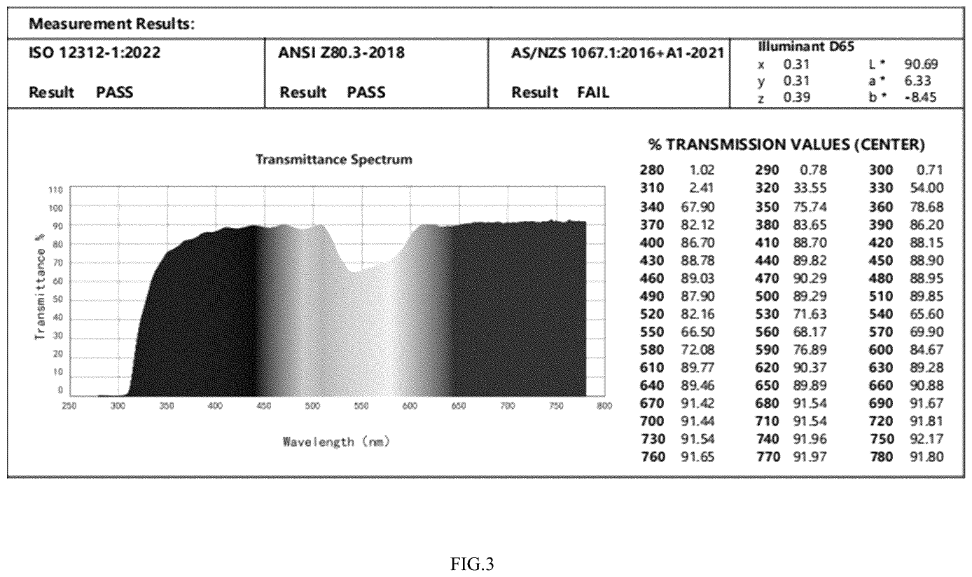

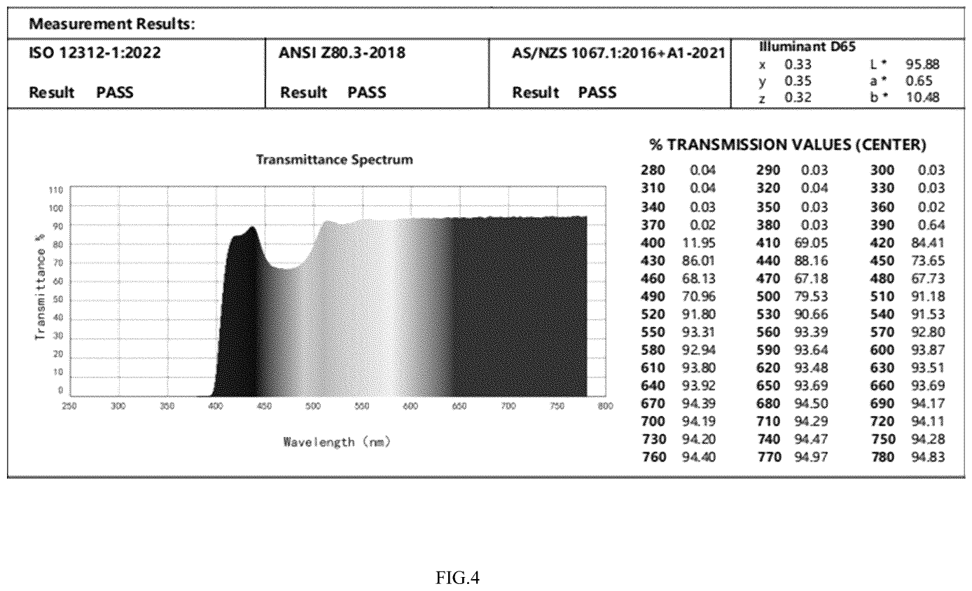

As shown in FIGS. 2 to 4, spectral curves of the high-flexibility iridescent film are provided. FIG. 2 corresponds to an iridescent film in red, with chromaticity (in CIELAB color space) of L*=94.09, a*=−4.53, b*=0.19, and the spectrum showing obvious blocking at 620 nm to 710 nm, i.e., the reflection wavelength corresponding to red light region, with a color of appearance being transparent light red. FIG. 3 corresponds to an iridescent film in green, with chromaticity (in CIELAB color space) of L*=90.69, a*=6.33, b*=−8.45, and the spectrum showing obvious blocking at 530 nm to 590 nm, i.e., the reflection wavelength corresponding to a green light region, with a color of appearance being transparent light green. FIG. 4 corresponds to an iridescent film in blue, with chromaticity (in CIELAB color space) of L*=95.88, a*=0.65, b*=10.48, and the spectrum showing obvious blocking at 450 nm to 500 nm, i.e., the reflection wavelength corresponding to a blue light region, with a color of appearance being transparent light blue.

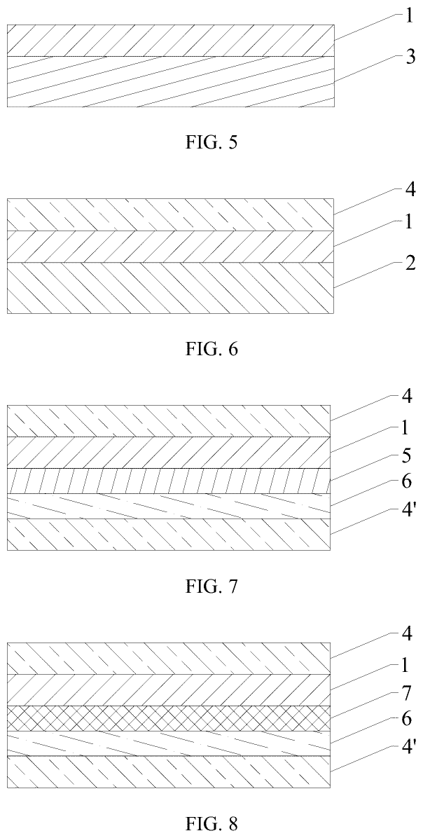

As shown in FIG. 5, a fourth embodiment of the present invention discloses a high-flexibility iridescent transfer film, comprising a release film 3 and an iridescent coating 1 disposed on the release film 3; the iridescent coating 1 is formed on a surface of the release film 3 using the coating process according to the third embodiment; after tearing off the release film 3, the high-flexibility iridescent transfer film transfers the iridescent coating 1 to a surface of a target substrate; the release film 3 is one of the following materials: TAC, PC, PA, PMMA, and plastics.

As shown in FIG. 6, a fifth embodiment of the present invention discloses a high-flexibility iridescent protective film, comprising a protective film 4, an iridescent coating 1, and a substrate layer 2 disposed sequentially one over another; the iridescent coating 1 is formed on a surface of the substrate layer 2 using the coating process of the third embodiment; the protective film 4 is one of the following: a hardened film, a self-repairing film, an anti-oil hardened film, or an anti-seawater hardened film, with a thickness being 20 μm to 30 μm; the substrate layer 2 is one of the following: TAC, PC, PA, PMMA, glass, plastics, and a lens.

As shown in FIG. 7, a sixth embodiment of the present invention discloses a high-flexibility iridescent colored film, comprising a first protective film 4, an iridescent coating 1, a colored film 5, an anti-UV film 6, and a second protective film 4′ disposed sequentially one over another; the iridescent coating 1 is formed on a surface of the colored film 5 using the coating process of the third embodiment; each of the first protective film 4 and the second protective film 4′ is one of the following: a hardened film, a self-repairing film, an anti-oil hardened film, and an anti-seawater hardened film, with a thickness being 20 μm to 30 μm.

As shown in FIG. 8, a seventh embodiment of the present invention discloses a high-flexibility iridescent color-changing film, comprising a first protective film 4, an iridescent coating 1, a color-changing film 7, an anti-UV film 6, and a second protective film 4′ disposed sequentially one over another; the iridescent coating 1 is formed on a surface of the color-changing film 7 using the coating process of the third embodiment; each of the first protective film 4 and the second protective film 4′ is one of the following: a hardened film, a self-repairing film, an anti-oil hardened film, and an anti-seawater hardened film, with a thickness being 20 μm to 30 μm.

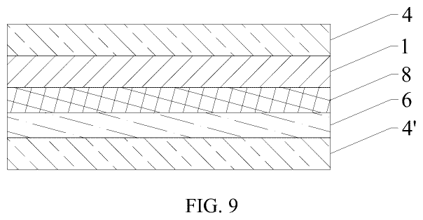

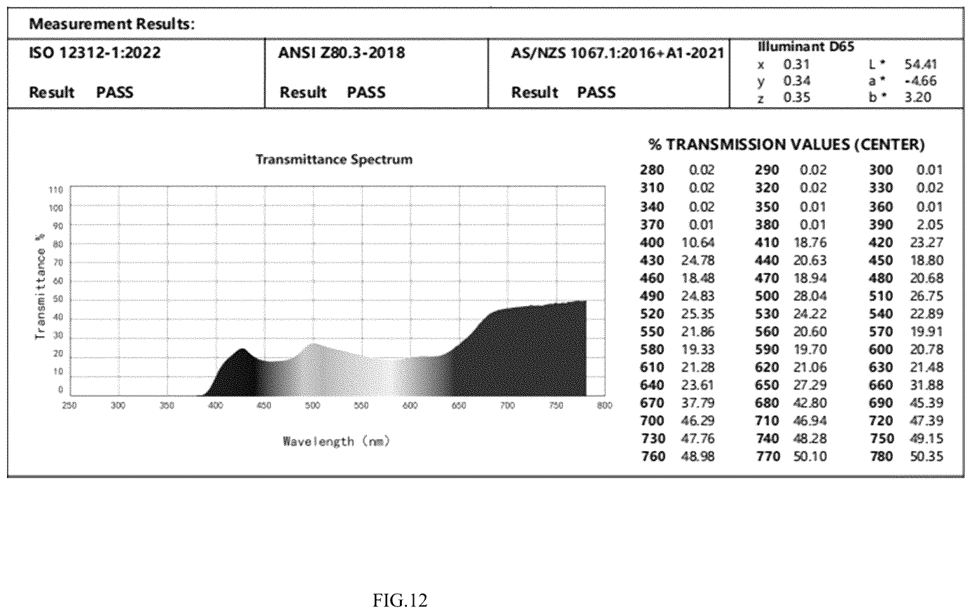

As shown in FIGS. 9 to 12, an eighth embodiment of the present invention discloses a high-flexibility iridescent polarizing film, comprising a first protective film 4, an iridescent coating 1, a polarizing film 8, an anti-UV film 6, and a second protective film 4′ disposed sequentially one over another; the iridescent coating 1 is formed on a surface of the polarizing film 8 using the coating process of the third embodiment; each of the first protective film 4 and the second protective film 4′ is one of the following: a hardened film, a self-repairing film, an anti-oil hardened film, and an anti-seawater hardened film, with a thickness being 20 μm to 30 μm.

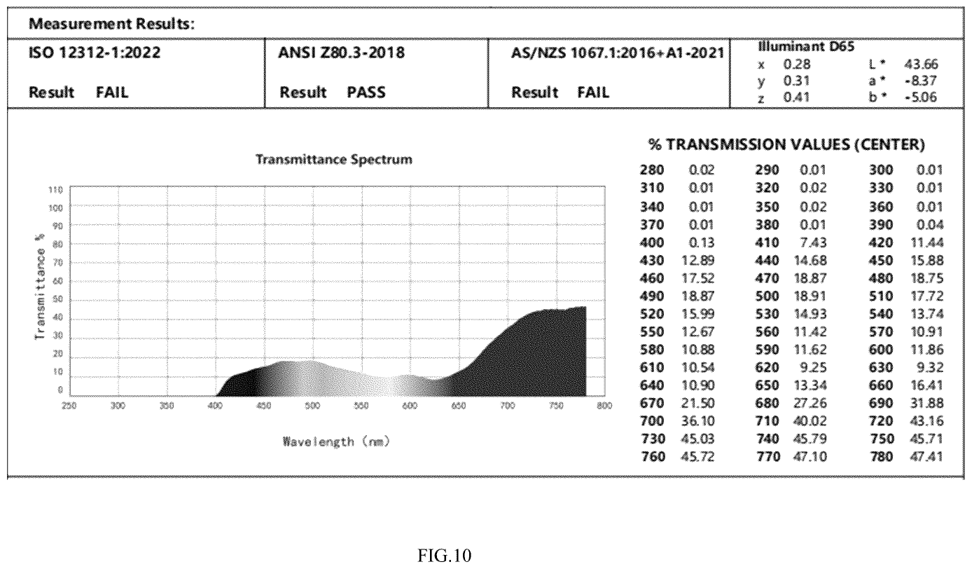

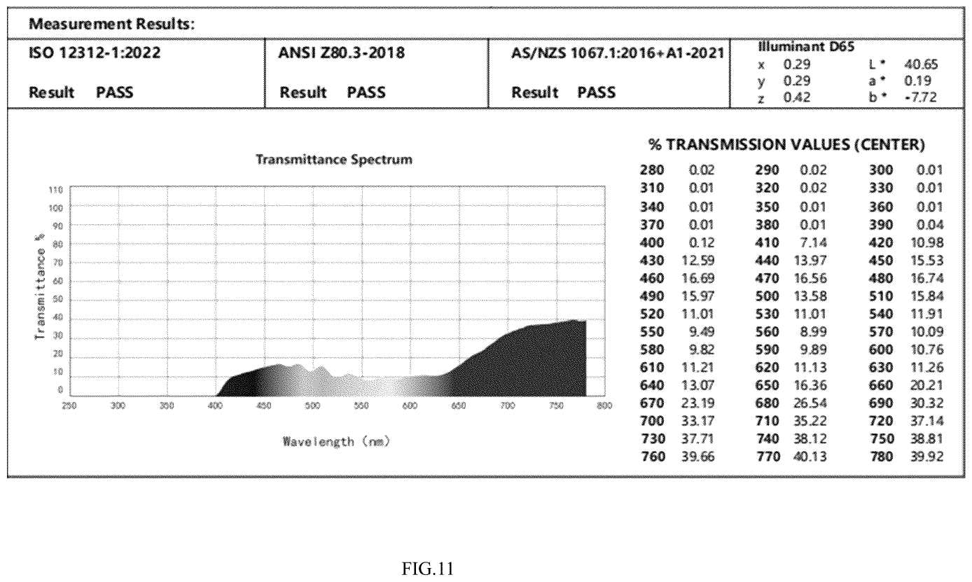

As shown in FIGS. 10 to 12, spectral curves of the high-flexibility iridescent polarizing film are provided; specifically, FIGS. 10-12 are spectral curve diagrams after combining iridescent films in red, green, and blue with the polarizing film respectively; since a color of the iridescent coating itself is a nearly transparent light color, after combining with the polarizing film, a transmittance thereof decreases, and since the lower a base color transmittance, the better a displayed color effect, the high-flexibility iridescent polarizing film has both a polarizing effect and a color-displaying effect similar to electroplating.

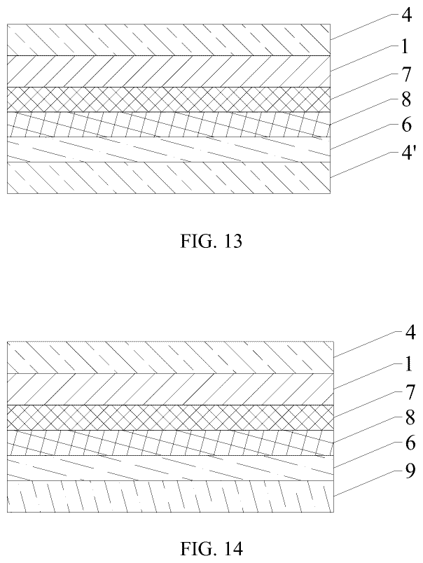

As shown in FIG. 13, a ninth embodiment of the present invention discloses a high-flexibility iridescent polarizing color-changing film, comprising a first protective film 4, an iridescent coating 1, a color-changing film 7, a polarizing film 8, an anti-UV film 6, and a second protective film 4′ disposed sequentially one over another; the iridescent coating 1 is formed on a surface of the color-changing film 7 using the coating process of the third embodiment; each of the first protective film 4 and the second protective film 4′ is one of the following: a hardened film, a self-repairing film, an anti-oil hardened film, and an anti-seawater hardened film, with a thickness being 20 μm to 30 μm.

As shown in FIG. 14, a tenth embodiment of the present invention discloses a high-flexibility anti-fog polarizing color-changing iridescent film, comprising a protective film 4, an iridescent coating 1, a color-changing film 7, a polarizing film 8, an anti-UV film 6, and an anti-fog film 9 disposed sequentially one over another; the iridescent coating 1 is formed on a surface of the color-changing film 7 using a coating process of the third embodiment; the protective film 4 is one of the following: a hardened film, a self-repairing film, an anti-oil hardened film, and an anti-seawater hardened film, with a thickness being 20 μm to 30 μm; the anti-fog film 9 is a TAC anti-fog film.

According to the above solutions, the present invention aims to address deficiencies of electroplated lenses which are weak in flexibility and resistance to chemical corrosion, as well as issues such as susceptibility to cracking of the electroplated layer when bent to greater curvatures. The present invention provides an innovative coating solution formula. The coating solution obtained can be used to prepare an iridescent film having high flexibility and multi-angle color display; the iridescent film is based on known principles of anisotropy of liquid crystals and Bragg reflection to display colors by multi-layer superposition and interference. Thus, the present invention can retain all beneficial effects of electroplated lenses, and at the same time solving problems like the lack of resistance to chemical corrosion, insufficient flexibility, and susceptibility to cracking at greater curvatures existing in prior art electroplated sheets. A finished product of the flexible iridescent film can be supplied in form of a roll, preventing increased process steps, rising production costs, and resource waste caused by conventional electroplating processes.

The above embodiments and drawings do not limit a product form and style of the present invention; any appropriate changes or modifications made by those of ordinary skill in the art should be considered as not departing from the scope of the present invention.

1. A coating solution formula, comprising the following ingredients: a cholesteric liquid crystal epoxy resin, acetone, butyl glycidyl ether, a chiral dopant, and triethylenetetramine.

2. The coating solution formula of claim 1, wherein a ratio of one or both of the acetone and the butyl glycidyl ether to the chiral dopant is adjusted to adjust a pitch of liquid crystal molecules in the coating solution formula according to predetermined requirements for a reflection wavelength; the reflection wavelength λ is obtained by λ=2n·P·sin Φ, and
$$λ = \frac{2 n \cdot sin Φ}{C \cdot β M} ,$$
wherein
$$n = \frac{2 {n}_{0} + {n}_{e}}{3}$$
represents an average refractive index of the liquid crystal molecules, n₀ represents an ordinary refractive index, nₑ represents an extraordinary refractive index, P represents the pitch, Φ represents an angle between incident light and a surface of a liquid crystal, C represents a concentration of the chiral dopant, and βM represents a helical twisting power.

3. The coating solution formula of claim 2, wherein mass percentages of the ingredients in the coating solution formula are: the cholesteric liquid crystal epoxy resin accounts for 42% of the coating solution, the acetone accounts for 33% of the coating solution, the butyl glycidyl ether accounts for 20% of the coating solution, the chiral dopant accounts for 0.4% of the coating solution, and the triethylenetetramine accounts for 4.6% of the coating solution.

4. The coating solution formula of claim 1, wherein the chiral dopant is chiral dopant S811.

5. A manufacturing method of a coating solution, implemented in a dust-free environment at a constant temperature of 23 °C±1 °C and a constant pressure, comprising the following steps:
step 1: collecting the ingredients according to the coating solution formula of claim 1, placing the cholesteric liquid crystal epoxy resin in a stirrer, and stirring the cholesteric liquid crystal epoxy resin at a uniform speed of 35 r/min in a clockwise direction;
step 2: maintaining a rotation speed of the stirrer, adding the acetone and the butyl glycidyl ether into the stirrer, and continuing stirring for 30 minutes;
step 3: maintaining the rotation speed of the stirrer, adding the chiral dopant into the stirrer, and continuing stirring for 30 minutes;
step 4: maintaining the rotation speed of the stirrer, adding the triethylenetetramine into the stirrer, continuing stirring for 60 minutes until a liquid crystal phase is uniformly dispersed, and then stopping the stirrer; and finally allowing the ingredients to rest, vacuuming to remove air to obtain the coating solution.

6. A manufacturing method of the coating solution, implemented in a dust-free environment at a constant temperature of 23 °C±1 °C and a constant pressure, comprising the following steps:
step 1: collecting and adjusting the ingredients according to the coating solution formula of claim 2, placing the cholesteric liquid crystal epoxy resin in a stirrer, and stirring the cholesteric liquid crystal epoxy resin at a uniform speed of 35 r/min in a clockwise direction;
step 2: maintaining a rotation speed of the stirrer, adding the acetone and the butyl glycidyl ether into the stirrer, and continuing stirring for 30 minutes;
step 3: maintaining the rotation speed of the stirrer, adding the chiral dopant into the stirrer, and continuing stirring for 30 minutes;
step 4: maintaining the rotation speed of the stirrer, adding the triethylenetetramine into the stirrer, continuing stirring for 60 minutes until a liquid crystal phase is uniformly dispersed, and then stopping the stirrer; and finally allowing the ingredients to rest, vacuuming to remove air to obtain the coating solution.

7. A manufacturing method of the coating solution, implemented in a dust-free environment at a constant temperature of 23 °C±1 °C and a constant pressure, comprising the following steps:
step 1: collecting and adjusting the ingredients according to the coating solution formula of claim 3, placing the cholesteric liquid crystal epoxy resin in a stirrer, and stirring the cholesteric liquid crystal epoxy resin at a uniform speed of 35 r/min in a clockwise direction;
step 2: maintaining a rotation speed of the stirrer, adding the acetone and the butyl glycidyl ether into the stirrer, and continuing stirring for 30 minutes;
step 3: maintaining the rotation speed of the stirrer, adding the chiral dopant into the stirrer, and continuing stirring for 30 minutes;
step 4: maintaining the rotation speed of the stirrer, adding the triethylenetetramine into the stirrer, continuing stirring for 60 minutes until a liquid crystal phase is uniformly dispersed, and then stopping the stirrer; and finally allowing the ingredients to rest, vacuuming to remove air to obtain the coating solution.

8. A manufacturing method of a coating solution, implemented in a dust-free environment at a constant temperature of 23 °C±1 °C and a constant pressure, comprising the following steps:
step 1: collecting the ingredients according to the coating solution formula of claim 4, placing the cholesteric liquid crystal epoxy resin in a stirrer, and stirring the cholesteric liquid crystal epoxy resin at a uniform speed of 35 r/min in a clockwise direction;
step 2: maintaining a rotation speed of the stirrer, adding the acetone and the butyl glycidyl ether into the stirrer, and continuing stirring for 30 minutes;
step 3: maintaining the rotation speed of the stirrer, adding the chiral dopant into the stirrer, and continuing stirring for 30 minutes;
step 4: maintaining the rotation speed of the stirrer, adding the triethylenetetramine into the stirrer, continuing stirring for 60 minutes until a liquid crystal phase is uniformly dispersed, and then stopping the stirrer; and finally allowing the ingredients to rest, vacuuming to remove air to obtain the coating solution.

9. An iridescent film, comprising at least one substrate layer and an iridescent coating coated on a surface of one of said at least one substrate layer; said iridescent coating comprises a coating solution obtained according to the coating solution formula of claim 1; the coating solution is nano-spray coated on the surface of one of said at least one substrate layer to obtain said iridescent coating.

10. The iridescent film of claim 9, wherein said at least one substrate layer is a glass material or a plastics material, and the plastics material is one or more of Tri-Acetyl Cellulose (TAC), Polycarbonate (PC), Polyamide (PA), and Poly-methyl methacrylate (PMMA).

11. An iridescent film, comprising at least one substrate layer and an iridescent coating coated on a surface of one of said at least one substrate layer; said iridescent coating comprises the coating solution obtained according to the coating solution formula of claim 2; the coating solution is nano-spray coated on the surface of one of said at least one substrate layer to obtain said iridescent coating.

12. An iridescent film, comprising at least one substrate layer and an iridescent coating coated on a surface of one of said at least one substrate layer; said iridescent coating comprises the coating solution obtained according to the coating solution formula of claim 3; the coating solution is nano-spray coated on the surface of one of said at least one substrate layer to obtain said iridescent coating.

13. An iridescent film, comprising at least one substrate layer and an iridescent coating coated on a surface of one of said at least one substrate layer; said iridescent coating comprises the coating solution obtained according to the coating solution formula of claim 4; the coating solution is nano-spray coated on the surface of one of said at least one substrate layer to obtain said iridescent coating.
